(19) United States
(12) Patent Application Publication
(10) Pub. No.: US 2024/0232500 A1
(43) Pub. Date: Jul. 11, 2024

(54) METAL-INSULATOR-METAL CAPACITOR INSERTION

(71) Applicant: Synopsys, Inc., Sunnyvale, CA (US)

(72) Inventors: Bohai LIU, Shanghai (CN); Gary K. LEAP, Fremont, CA (US); Hao CAI, Shanghai (CN); Xinshi ZANG, Shatin, Nt (HK)

(21) Appl. No.: 18/560,283

(22) PCT Filed: Jun. 7, 2021
(86) PCT No.: PCT/CN2021/098550

§ 371 Date: Nov. 10, 2023

(51) Int. Cl. G06F 30/394; G06F 30/392; G06F 119/06

(52) U.S. Cl. CPC G06F 30/394; G06F 30/392; G06F 2119/06

(57) ABSTRACT

Metal-Insulator-Metal (MIM) Capacitor insertion is provided by grouping subsets of Power Grid (PG) routings from a plurality of PG routings in a circuit design; inserting MIM capacitors into each of the grouped subsets of the PG routings based on a layout and spacing of the PG routings in corresponding grouped subsets of the PG routings; and connecting, for each of the grouped subset of the PG routings, pins of each of the MIM capacitors inserted therein to associated PG routing pairs.

### TECHNICAL FIELD

The present disclosure relates to the insertion of Metal-Insulator-Metal (MIM) capacitors in relation to Power Grid (PG) routings. Advantages of the techniques described herein include increased capacitance density, improvements in Voltage (IR) drop, PG net routability, and ease of use in the physical design of integrated circuits.

### BACKGROUND

The on-chip capacitor is a critical component in integrated circuits (also referred to as chips), which plays a significant role in various fields such as power storage and voltage stabilization. Many new materials, new structures, and new processing techniques related to capacitors have been devised to enhance the capacitance density, which needs be as high as possible given the limited area of integrated circuits. Among multiple kinds of capacitors, the Metal-Insulator-Metal (MIM) capacitor is often used because of the high capacitance per unit area with low parasitic capacitance offered by the MIM design.

### BRIEF DESCRIPTION OF THE DRAWINGS

The disclosure will be understood more fully from the detailed description given below and from the accompanying figures of examples described herein. The figures are used to provide knowledge and understanding of examples described herein and do not limit the scope of the disclosure to these specific examples. Furthermore, the figures are not necessarily drawn to scale.

FIGS. 1A and 1B illustrate views of a MIM capacitor, according to aspects of the present disclosure.

FIGS. 2A and 2B illustrate MIM capacitor insertion and alignment, according to aspects of the present disclosure.

FIG. 3 illustrate a flowchart of a method for inserting of MIM capacitors into a circuit design, according to aspects of the present disclosure.

FIG. 4 illustrates grouping of different PG routings, according to aspects of the present disclosure.

FIG. 5 illustrates the reconstruction of overlapping PG routing groups, according to aspects of the present disclosure.

FIG. 6 illustrates overlap between the pins of a MIM capacitor and PG routings, according to aspects of the present disclosure.

FIG. 7 depicts a flowchart of various processes used during the design and manufacture of an integrated circuit in accordance with some examples of the present disclosure.

FIG. 8 depicts a diagram of an example computer system in which examples of the present disclosure may operate.

### SUMMARY

In one embodiment, the present disclosure provides a method comprising: grouping subsets of Power Grid (PG) routings from a plurality of PG routings in a circuit design; inserting Metal-Insulator-Metal (MIM) capacitors into each of the grouped subsets of the PG routings based on a layout and spacing of the PG routings in corresponding grouped subsets of the PG routings; and connecting, for each of the grouped subset of the PG routings, pins of each of the MIM capacitors inserted therein to associated PG routing pairs.

### DETAILED DESCRIPTION

Aspects described herein relate to addressing the problems associated with inserting Metal-Insulator-Metal (MIM) capacitors in chips. Rather than first inserting MIM capacitors in a fixed and regular pattern and then connecting the MIM capacitors with the Power Grid (PG), the present disclosure describes inserting MIM capacitors by automatically aligning the MIM capacitors to PG routings upon insertion. Because the PG can be locally irregular (e.g., with missing rails, jogs, and different pitches), MIM capacitors inserted in the regular pattern may need stub routings (relatively shot traces linking the MIM capacitor pins to a PG) to connect to the locally variant PG. In some circuit designs, these MIM capacitors are removed when the stub routing cannot be completed (e.g., violating routing design rules), giving rise to the decrease of capacitance density and the increase of insertion complexity. All of which the present disclosure avoids by using patterns of MIM capacitors that are unfixed and that can instead flexibly follow any arbitrary local variations of PG routing, thus potentially improving capacitance density, easing design routability, and improving Voltage (IR) drop, among other benefits.

In some aspects, better (e.g., lower) IR drop can be achieved with more MIM capacitors inserted in a chip. Instead of removing MIM capacitors that violate Design Rule Check (DRC) in the classical method, the present disclosure prioritizes the alignment of MIM capacitors to PG routings, thereby reducing DRC violations and permitting more MIM capacitors to be included in the final circuit design.

In some aspects, the present disclosure further improves the routability of PG nets to thereby save considerable computing resources when placing routes. Because the inserted MIM capacitors have already been physically aligned to PG routings, the connection between MIM capacitors and PG routings can be directly realized and extra stub routing may be avoided. Although stub routing is avoided by the present disclosure, the present disclosure does not preclude the use of stub routings, and may include the use of stub routing in some situations. For example, a layout designer can align one of the capacitor pins to a PG routing and use stub routing for the other pin to a different PG routing. In various aspects, the layout designer can be an automatic procedure executed by a design system, a human designer, or any means provided in software, hardware, and combinations thereof capable of designing or modifying an integrated circuit layout.

In some aspects, the Ease of Use (EoU) for insertion of MIM capacitors can also be observably improved. Reducing or removing the MIM capacitors that cause DRC violations when using fixed-pattern MIM insertion can be computationally difficult to perform. In contrast, the present disclosure provides for automatically adjusting the patterns of MIM capacitors to the patterns of PG routings to thereby simplify the patterning of the MIM capacitors in the circuit design.

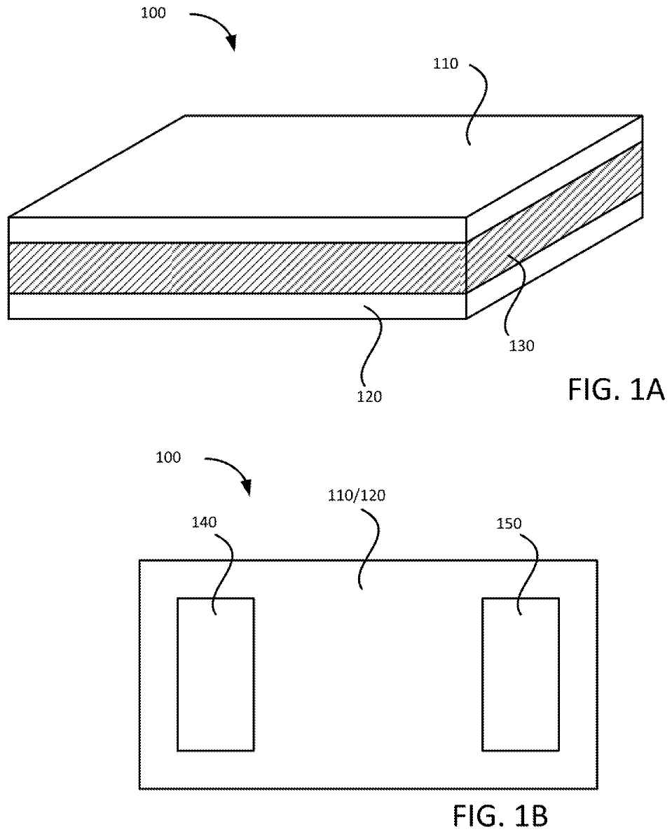

FIGS. 1A-1B illustrate views of a MIM capacitor 100, according to aspects of the present disclosure.

As shown in FIG. 1A, a MIM capacitor 100 includes at least two parallel metal plates (e.g., a top metal 110, and a bottom metal 120) separated by a dielectric material (e.g., insulator 130). Although illustrated in FIG. 1A as including two plates separated by one layer of the dielectric, in various aspects, a MIM capacitor 110 can include n plates (where n≥2) with n−1 layers of dielectric sandwiched between two of the plates.

As shown in FIG. 1B, the top metal 110 and the bottom metal 120 include pins to separately connected each of the outer plates plate to the power (e.g., via VDD 150) and ground (e.g., VSS 140) routing of the PG in an integrated circuit.

If improperly placed, or placed in such a way that would require a stub routing in the integrated circuit, these MIM capacitors 100 can be difficult to connect to the PG, and may be removed from the circuit design to avoid computationally resource intensive routing operations (e.g., stub routing). However, because the MIM capacitors 100 act as a secondary power supply, designers generally prefer including more MIM capacitors 100 rather than fewer in a given circuit design. To reduce the number of improperly placed MIM capacitors 100, the present disclosure inserts MIM capacitors 100 with automatic alignment to the PG routings.

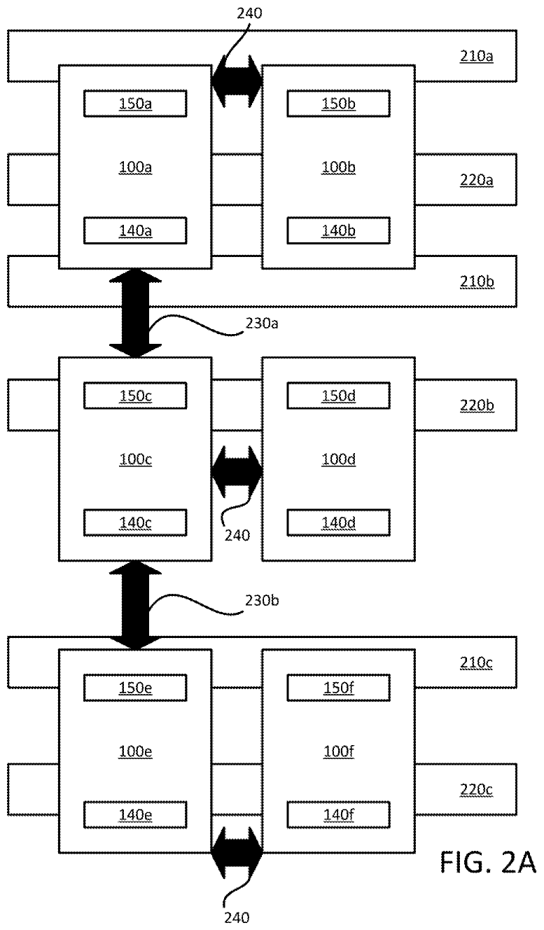

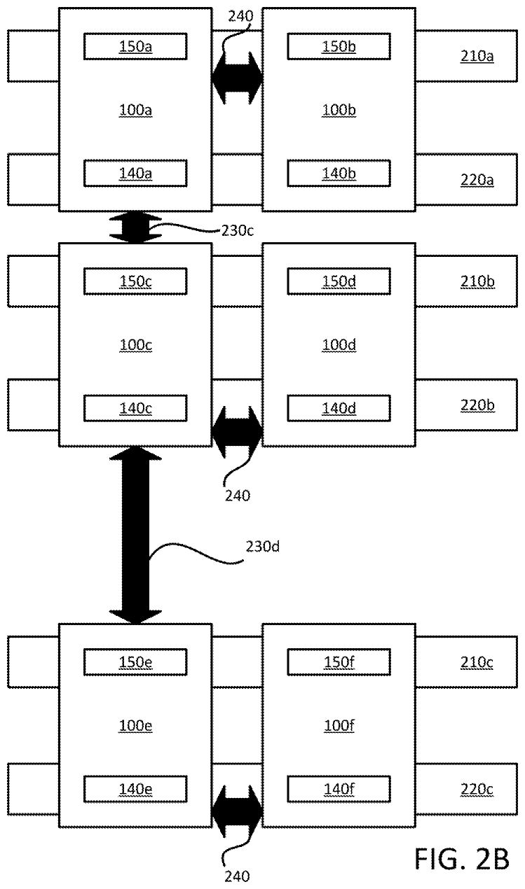

FIGS. 2A and 2B illustrate MIM capacitor insertion and alignment, according to aspects of the present disclosure. In each of FIGS. 2A and 2B, a plurality of power routings 210a-c (generally or collectively, power routings 210) and ground routings 220a-c (generally or collectively, ground routings 220) define the PG routings. The spacing between the various power routings 210 and the ground routings may exhibit locally variances so that the distances between neighboring PG routings are unequal in the circuit design. Both FIGS. 2A and 2B show the same layout and spacing of power routings 210 and ground routings 220. In each of FIGS. 2A and 2B, the spacing between the MIM capacitors 100 vary in one direction (perpendicular to the length of the PG routings), but the MIM capacitors 100 are evenly spaced along the length of the PG routings according to a fixed distance 240 that is at least as great as a minimum spacing threshold distance, but may be any system-defined, user-defined, or inferred/calculated value.

FIG. 2A illustrates a patterned approach in which MIM capacitors 100a-f (generally or collectively, MIM capacitors 100) are inserted based on a two-dimensional grid pattern with fixed horizontal and vertical (dx/dy) spacing between the MIM capacitors 100. Accordingly, the first distance 230a between the first MIM capacitor 100a and the third MIM capacitor 100c is the same as the second distance 230b between the third MIM capacitor 100c and the fifth MIM capacitor 100e. When using a patterned approach, additional routing steps (e.g., stub route) may be needed to adapt the MIM capacitors 100 follow a locally variant PG structure (e.g., the first VDD pin 150a is electrically disjoint from the first power routing 210a without a stub route), and MIM capacitors 100 that cannot be adapted to the PG structure are removed from the circuit design.

In contrast, FIG. 2B illustrates a PG-matched approach in which only the minimum dx/dy between MIM capacitors 100 is specified (e.g., to ensure that the fixed distance 240 and the variable distances 230c-d conform to design specifications) and MIM capacitors 100 can be placed by automatically adjusting the insertion thereof into the PG routings based on the existing layout and spacing of the PG routings. Accordingly, the third distance 230c between the first MIM capacitor 100a and the third MIM capacitor 100c is the different from the fourth distance 230d between the third MIM capacitor 100c and the fifth MIM capacitor 110e. As a result, a PG-matched approach can greatly improve the EoU for insertion of MIM capacitors 100 compared to a patterned approach.

As shown in FIG. 2A, when inserting the MIM capacitors 100 according to a patterned approach, the MIM capacitors 100 can be out of the reach of PG routings and may eventually unconnected to any PG routing or may be unintentionally connected to (unintended) PG routings due to a mismatch between the corresponding pins 140a-f/150a-f of MIM capacitors 100a-f and PG routings. These mismatched MIM capacitors 100 are removed after initial insertion, resulting in the decrease of the number of MIM capacitors 100 in the final circuit design. For example, the third and fourth MIM capacitors 100c-d may be too far from the second power routing 210b or second ground routing 220b to connect the respective VDD pin 150c-d or ground pin 140c-d via stub routings, and may be removed from the final circuit design.

In contrast, the MIM capacitors 100 inserted based on the PG-match approach in FIG. 2B always match with PG routings, and result fewer DRC violations due to the placement of the MIM capacitors 100. With a greater number of the inserted MIM capacitors 100 remaining inserted in the chip, the present disclosure can improve the capability of MIM capacitors 100 regarding power storage and voltage stabilization, and therefore lead to better IR drop for the whole integrated circuit.

Additionally, because the patterned approach shown in FIG. 2A inserts MIM capacitors 100 without considering PG routings, the MIM capacitors 100 can be far away from PG routings. Although these distant MIM capacitors 100 can remain in the circuit design, additional routing steps are required to connect these distant MIM capacitors 100 to the PG routings. In contrast, as shown in FIG. 2B, the inserted MIM capacitors 100 are already aligned to the PG routings with pins matching with and covered by the PG routings, thus resulting in direct connections that can be made without the demand of extra routing steps. Hence, the routability of PG nets can be improved and valuable routing resources can be conserved.

Moreover, the present disclosure improves not only the insertion of MIM capacitors 100, but improves the flexibility of creating PG routings or rails. It is unnecessary for PG routings to match the spacing between VDD pin 150 and VSS pin 140 of a MIM capacitor 100. Minor local variation of PG routings is acceptable. Accordingly, the present disclosure improves the insertion of MIM capacitors 100 by aligning the MIM capacitors 100 to the existing PG routings.

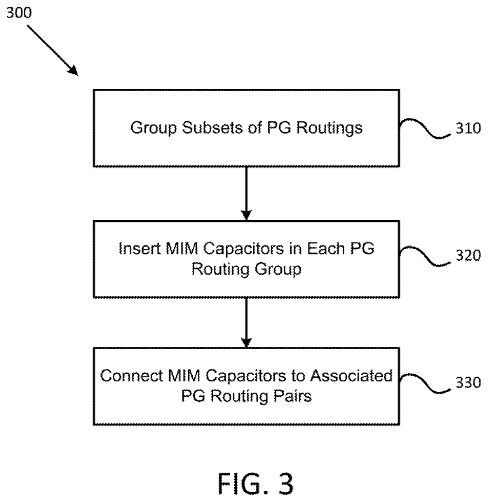

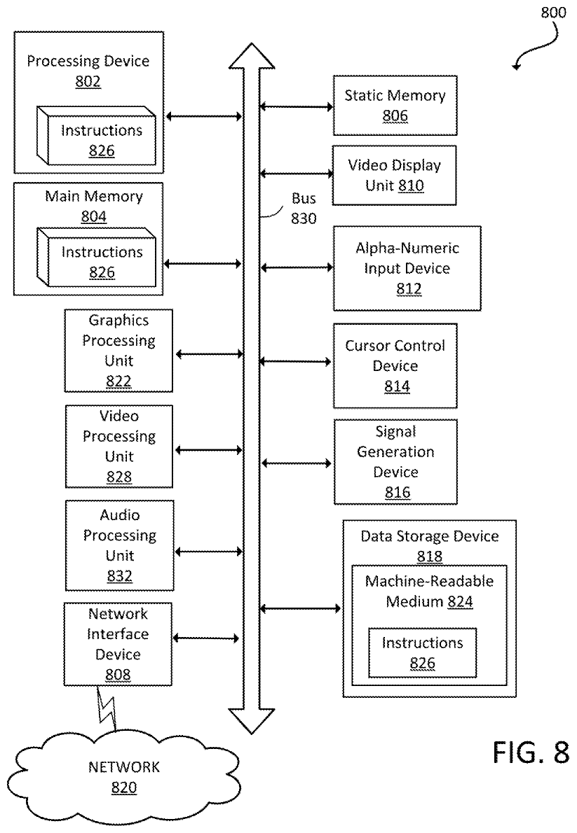

FIG. 3 illustrate a flowchart of a method 300 for inserting of MIM capacitors into a circuit design, according to aspects of the present disclosure. In method 300, a layout designer, such as the computing system 0200 illustrated in FIG. 8, filters and categorizes related PG routings, inserts MIM capacitors and physically aligns the MIM capacitors to the PG routings, and logically connects the MIM capacitors to the PG routings.

At block 310, the layout designer selects the subset of PG routings from the set of all PG routings and further classifies these PG routings into different groups based on the voltage rating, alignment, and length thereof. In various aspects, the circuit design may include one or more groups of PG routings. For example, a first group or subset is identified to include power routings 210 and ground routings 220 for X Volts (V), that have a length of Y millimeters (mm), and are aligned in direction Z, while a second group or subset is identified to include power routings 210 and ground routings 220 with different values of at least one of X, Y, or Z. Each of the power routings 210 in a given group carries the same voltage from the same source and the power routings 210 in different groups can carry different voltages or use different sources. Although referred to as ground routings 220, the ground routings 220 in different groups can include differently isolated group connections.

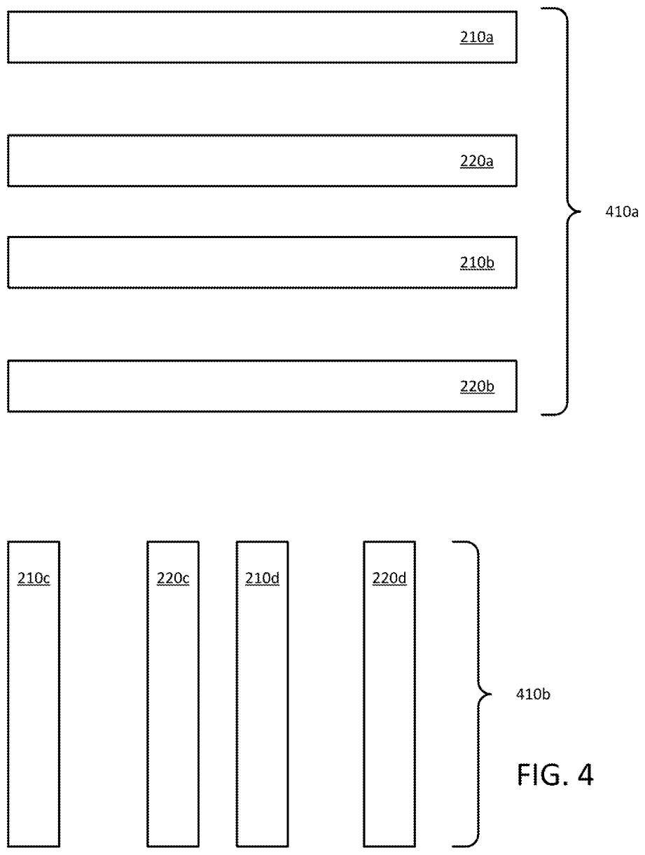

As illustrated in FIG. 4, the layout designer has selected a first group 410a of horizontal PG routings of the same length as one another, and a second group 410b of vertical PG routings that are the same length as one another. Although referred to as the “length” of the PG routings, the term length shall be understood to describe the longest dimension of a PG routing regardless of the orientation in space. Stated differently, the length of the horizontal PG routings is defined in the horizontal direction and the length of the vertical PG routings is defined in the vertical direction.

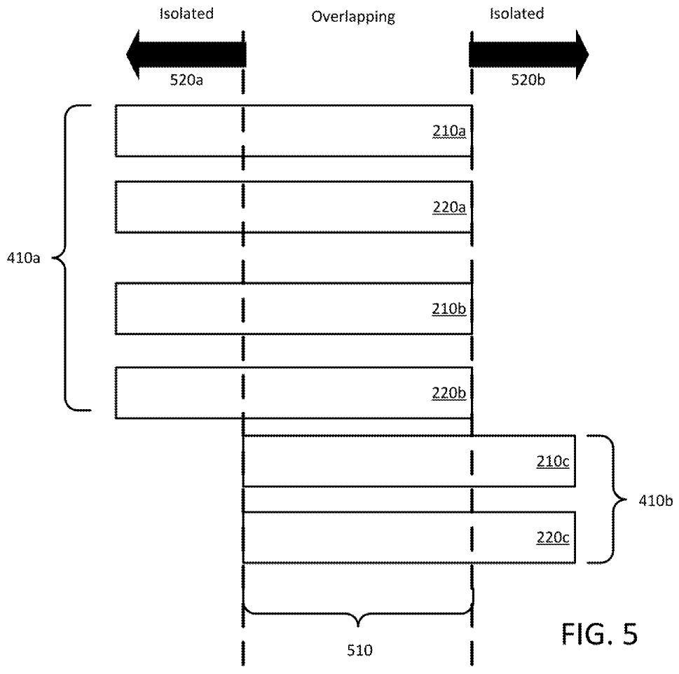

In some aspects of block 310, after the initial PG routings are grouped, the layout designer optionally identifies whether the PG routings in two or more adjacent groups overlap with one another in such a way that could construct a new group from the adjacent groups. For example, a first group and a second group can be overlapped to then be analyzed as a third group (e.g., the overlapped group of FIG. 5) when the power and ground inputs are equivalent between the PG routings of the two initial groups.

FIG. 5 illustrates the construction of overlapping PG routing groups, according to aspects of the present disclosure. As shown in FIG. 5, the layout designer has identified a first group 410a of PG routings adjacent to a second group 410b of PG routings aligned in the same direction and connected to the same power and ground inputs, but with different lengths or layouts. The layout designer can treat each of the first group 410a and the second group 410b as separate groups when inserting MIM capacitors 100, but can also identify the regions of the two groups 410a-b that overlap (e.g., the subset of the lengths that are shared by all of the PG routings) to evaluate as a third overlapping PG group 510 that excludes any isolated portions 520a, 520b of those PG routings that are not shared by all the PG routings in the two groups 410a/b. This third overlapping group 510 can be analyzed in addition to or instead of the initial groups 410a/b in various aspects.

At block 320, the layout designer inserts MIM capacitors 100 in each PG routing group. The layout designer traverses the PG routings in each group (e.g., from bottom to top or from left to right) in order to find paired power routings 210 and ground routings 220 to which the MIM capacitors 100 can be aligned. In various aspects, the layout designer determines whether MIM capacitors 100 can be aligned to a given PG routing pair based on whether the pins of MIM capacitors 100 can be totally covered by the corresponding PG routings. When inserting the MIM capacitors into each of the PG routing groups, the layout designer spaces the MIM capacitors according to fixed distance (at least as great as a minimum spacing distance) along a length of the paired PG routings and spaces the MIM capacitors 100 with variable distances (at least as great as a minimum spacing distance) between one another to align pins of the MIM capacitors 100 with associated PG routing pairs.

Referring back to FIG. 2B, the first MIM capacitor 100a is inserted according to a fixed spacing distance from the second MIM capacitor 100b (as are the third/fourth and fifth/sixth MIM capacitors 100c-f), while the third distance 230c and the third distance 230d depend on where the paired power routings 210 and ground routings 220 are located relative to one another.

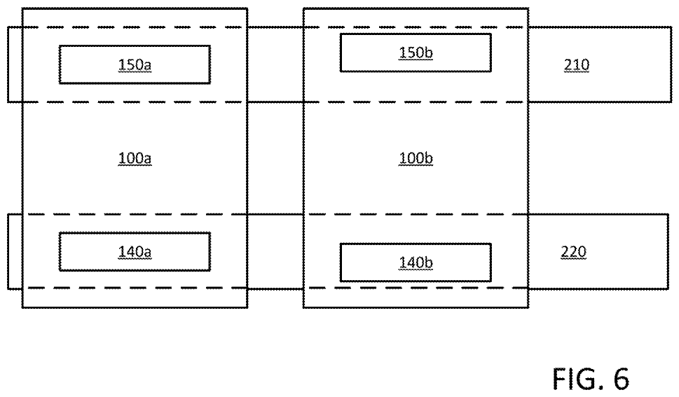

FIG. 6 illustrates overlap between the pins of MIM capacitors 100 and PG routings, according to aspects of the present disclosure. In FIG. 6, a first MIM capacitor 100a, whose VDD pin 150a and VSS pin 140a are covered by the ground routings 220 and power routings 210, can be aligned to this PG routing pair. The layout designer inserts the MIM capacitors 100 with the identified PG routing pairs and keeps the alignment and spacing for the MIM capacitors 100 from left-to-right or from bottom-to-top, depending on the orientation of the PG group (e.g., horizontal or vertical).

In various aspects, depending on the relative sizes of the pins and the PG routings, the distance between the pins, and the distance between the PG routing pair, the pins may be centered or uncentered relative to the PG routings. For example, the pins of the first MIM capacitor 100a are aligned on a shared centerline with the PG routings, while the pins of a second MIM capacitor 100b are not aligned on the centerline of the PG routings, but are still partially or totally covered by the PG routing pair.

When overlapping groups 510 are identified in block 310, the layout designer can evaluate capacitor densities when using the initial groups (e.g., the first group 410a and the second group 410b) compared to when using various overlapping groups 510 developed from the initial groups. In various aspects, the results of the evaluation can be sent to a user to select which grouping to use (e.g., groups A and B or overlapping group C made from groups A and B) or the layout designer can select the grouping that results in the higher overall capacitor density for the circuit design.

At block 330, the layout designer logically connects the MIM capacitors 100 with the associated pair of PG routings. Since the pins 140/150 of the MIM capacitors 100 have already been covered by the PG routings, the physical connections can done directly without introducing stub routings or identifying MIM capacitors 100 to remove from the circuit design. Although stub routing is avoided when performing method 300, method 300 does not preclude the use of stub routings in some situations. For example, a layout designer can align one of the capacitor pins to a PG routing and use stub routing for the other pin to a different PG routing. In another example, the layout designer can use method 300 without stub routing in a first subset of the PG routing groups, use method 300 with additional stub routing in a second subset of the PG routing groups, and use a patterned approach (e.g., as shown in FIG. 2A) in a third subset of the PG routing groups.

Various features are described herein with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the claimed subject matter or as a limitation on the scope of the claimed subject matter. In addition, an illustrated example need not have all the aspects or advantages shown. An aspect or an advantage described in conjunction with a particular example is not necessarily limited to that example and can be practiced in any other examples even if not so illustrated or if not so explicitly described. Further, methods described herein may be described in a particular order of operations, but other methods according to other examples may be implemented in various other orders (e.g., including different serial or parallel performance of various operations) with more or fewer operations.

Also, various terms are used herein as used in the art. For example, “optimization”, “optimize”, and “optimizing” refer, as used in the art and as understood by a person having ordinary skill in the art, to a mathematical formulation of a problem to select some improvement (if an improvement is available), within the structure of the algorithm implemented, of some identified characteristic, and do not imply an absolute or global optimal (as the term is more colloquially used) improvement of the characteristic. For example, in some situations where optimizing may determine a minimum, the minimum may be a local minima rather than the global minimum.

A person having ordinary skill in the art will readily understand various data structures that may be implemented in the processes described herein. For example, a class of mask objects can be defined for polygons and/or edges of polygons of a mask pattern. Similarly, a database or other storage structure can be implemented to store data of a PLT, Jacobian matrix, and/or CFG. Different data structures and/or modified data structures can be used in different examples.

Additionally, a person having ordinary skill in the art will readily understand various modifications to the logical and/or mathematical expressions of examples described herein. For example, different cost functions and/or approximations can be defined and used for calculations. Further, terms such as vector, table, and matrix are generally thought of as mathematical expressions, and related terms, such as column and row, similarly can be organizations within a mathematical expression and can be changed to different organizations. Other examples contemplate such modifications.

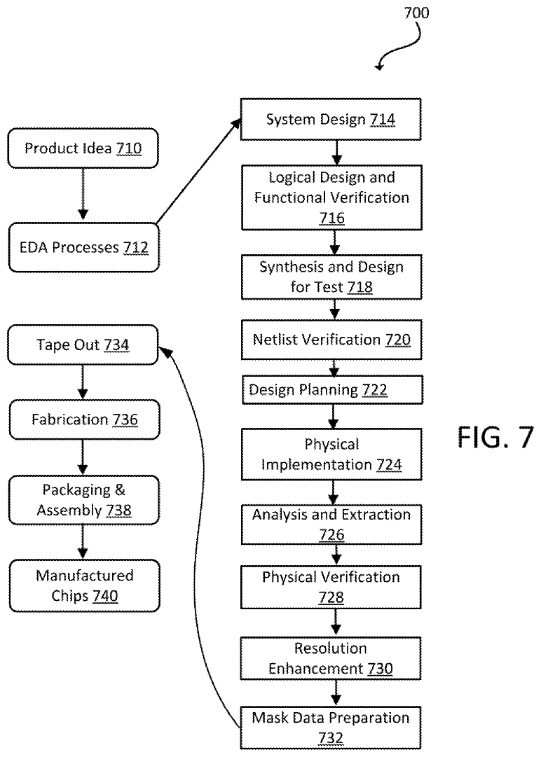

FIG. 7 illustrates an example set of processes 0100 used during the design, verification, and fabrication of an integrated circuit on a semiconductor die to transform and verify design data and instructions that represent the integrated circuit. Each of these processes can be structured and enabled as multiple modules or operations. The term “EDA” signifies Electronic Design Automation. These processes start, at 0110, with the creation of a product idea with information supplied by a designer, information that is transformed to create an integrated circuit that uses a set of EDA processes, at 0112. When the design is finalized, the design is taped-out, at 0134, which is when artwork (e.g., geometric patterns) for the integrated circuit is sent to a fabrication facility to manufacture the mask set, which is then used to manufacture the integrated circuit. After tape-out, at 0136, the integrated circuit is fabricated on a semiconductor die, and at 0138, packaging and assembly processes are performed to produce, at 0140, the finished integrated circuit (oftentimes, also referred to as “chip” or “integrated circuit chip”).

Specifications for a circuit or electronic structure may range from low-level transistor material layouts to high-level description languages. A high-level of representation may be used to design circuits and systems, using a hardware description language (HDL) such as VHDL, Verilog, SystemVerilog, SystemC, MyHDL or OpenVera. The HDL description can be transformed to a logic-level register transfer level (RTL) description, a gate-level description, a layout-level description, or a mask-level description. Each lower representation level that is a less representative description adds more useful detail into the design description, such as, for example, more details for the modules that include the description. The lower levels of representation that are less representative descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding tools of that layer (e.g., a formal verification tool). A design process may use a sequence depicted in FIG. 7. The processes described may be enabled by EDA products (or tools).

During system design, at 0114, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification, at 0116, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some examples, special systems of components, referred to as emulators or prototyping systems, are used to speed up the functional verification.

During synthesis and design for test, at 0118, HDL code is transformed to a netlist. In some examples, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification, at 0120, the netlist is checked for compliance with timing constraints and for correspondence with the HDL code. During design planning, at 0122, an overall floor plan for the integrated circuit is constructed and analyzed for timing and top-level routing.

During layout or physical implementation, at 0124, physical placement (positioning of circuit components, such as transistors or capacitors) and routing (connection of the circuit components by multiple conductors) occurs, and the selection of cells from a library to enable specific logic functions can be performed. As used herein, the term “cell” may specify a set of transistors, other components, and interconnections that provides a Boolean logic function (e.g., AND, OR, NOT, XOR) or a storage function (such as a flip-flop or latch). As used herein, a circuit “block” may refer to two or more cells. Both a cell and a circuit block can be referred to as a module or component and are enabled as both physical structures and in simulations. Parameters are specified for selected cells (based on standard cells) such as size and made accessible in a database for use by EDA products.

During analysis and extraction, at 0126, the circuit function is verified at the layout level, which permits refinement of the layout design. During physical verification, at 0128, the layout design is checked to ensure that manufacturing constraints are correct, such as design rule check (DRC) constraints, electrical constraints, lithographic constraints, and that circuitry function matches the HDL design specification. During resolution enhancement, at 0130, the geometry of the layout is transformed to improve how the circuit design is manufactured.

During tape-out, data is created to be used (after lithographic enhancements are applied if appropriate) for production of lithography masks. During mask data preparation, at 0132, the tape-out data is used to produce lithography masks that are used to produce finished integrated circuits.

A storage subsystem of a computer system (such as computer system 0200 of FIG. 8) may be used to store the programs and data structures that are used by some or all of the EDA products described herein, and products used for development of cells for the library and for physical and logical design that use the library.

FIG. 8 illustrates an example of a computer system 0200 within which a set of instructions, for causing the computer system to perform any one or more of the methodologies discussed herein, may be executed. In some implementations, the computer system may be connected (e.g., networked) to other machines or computer systems in a local area network (LAN), an intranet, an extranet, and/or the Internet. The computer system may operate in the capacity of a server or a client computer system in client-server network environment, as a peer computer system in a peer-to-peer (or distributed) network environment, or as a server or a client computer system in a cloud computing infrastructure or environment.

The computer system may be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that computer system. Further, while a single computer system is illustrated, the term computer system shall also be taken to include any collection of computer systems that individually or jointly execute a set (or multiple sets) of instructions to perform any one or more of the methodologies discussed herein.

The example computer system 0200 includes a processing device 0202, a main memory 0204 (e.g., read-only memory (ROM), flash memory, dynamic random access memory (DRAM) such as synchronous DRAM (SDRAM), a static memory 0206 (e.g., flash memory, static random access memory (SRAM), etc.), and a data storage device 0218, which communicate with each other via a bus 0230. The main memory 0204 includes or is a non-transitory computer readable medium. The main memory 0204 (e.g., a non-transitory computer readable medium) can store one or more sets of instructions 0226, that when executed by the processing device 0202, cause the processing device 0202 to perform some or all of the operations, steps, methods, and processes described herein.

Processing device 0202 represents one or more processors such as a microprocessor, a central processing unit, or the like. More particularly, the processing device 0202 may be or include complex instruction set computing (CISC) microprocessor, reduced instruction set computing (RISC) microprocessor, very long instruction word (VLIW) microprocessor, a processor implementing other instruction sets, or processor(s) implementing a combination of instruction sets. Processing device 0202 may also be one or more special-purpose processing devices such as an application specific integrated circuit (ASIC), a field programmable gate array (FPGA), a digital signal processor (DSP), network processor, or the like. The processing device 0202 may be configured to execute instructions 0226 for performing some or all of the operations, steps, methods, and processes described herein.

The computer system 0200 may further include a network interface device 0208 to communicate over the network 0220. The computer system 0200 also may include a video display unit 0210 (e.g., a liquid crystal display (LCD) or a cathode ray tube (CRT)), an alphanumeric input device 0212 (e.g., a keyboard), a cursor control device 0214 (e.g., a mouse), a graphics processing unit 0222, a signal generation device 0216 (e.g., a speaker), graphics processing unit 0222, video processing unit 0228, and audio processing unit 0232.

The data storage device 0218 may include a machine-readable storage medium 0224 (e.g., a non-transitory computer-readable medium) on which is stored one or more sets of instructions 0226 or software embodying any one or more of the methodologies or functions described herein. The instructions 0226 may also reside, completely or at least partially, within the main memory 0204 and/or within the processing device 0202 during execution thereof by the computer system 0200, the main memory 0204 and the processing device 0202 also including machine-readable storage media.

In some implementations, the instructions 0226 include instructions to implement functionality described above. While the machine-readable storage medium 0224 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the computer system and that cause the computer system and the processing device 0202 to perform any one or more of the methodologies described above. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (ROM), random access memory (RAM), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

1. A method, comprising:
grouping subsets of Power Grid (PG) routings from a plurality of PG routings in a circuit design;
inserting Metal-Insulator-Metal (MIM) capacitors into each of the grouped subsets of the PG routings based on a layout and spacing of the PG routings in corresponding grouped subsets of the PG routings; and
connecting, for each of the grouped subset of the PG routings, pins of each of the MIM capacitors inserted therein to associated PG routing pairs.

2. The method of claim 1, wherein the subsets of PG routings are identified to include power routings and ground routings for a given voltage range to connect to VDD pins and VSS pins of the MIM capacitors.

3. The method of claim 1, wherein the subset of PG routings include subsets of vertically aligned PG routings and subsets of horizontally aligned PG routings.

4. The method of claim 1, wherein a first MIM capacitor inserted into a given grouped subset of the PG routings is located a first distance from a second MIM capacitor inserted into the given grouped subset of the PG routings and a second distance from a third MIM capacitor inserted into the given grouped subset of the PG routings, wherein the first distance is different from the second distance, and wherein the first distance is measured in a direction opposite to the second distance.

5. The method of claim 1, wherein inserting the MIM capacitors into each of the grouped subsets of the PG routings includes:
spacing the MIM capacitors according to a fixed distance at least as great as a minimum spacing distance along a length of the grouped subsets of the PG routings; and
spacing the MIM capacitors with variable distances between the MIM capacitors to align pins of the MIM capacitors with associated PG routing pairs.

6. The method of claim 1, wherein the PG routings in each individual grouped subset of the grouped subsets of the PG routings have equal lengths.

7. The method of claim 1, wherein grouping the subsets of the PG routings from the plurality of PG routings in the circuit design includes:
identifying a first subset of the PG routings adjacent to a second subset of the PG routings in the circuit layout;
identifying an overlapping region of the PG routings shared by the first subset of the PG routings and the second subset of the PG routings;
generating an overlapping group based on the overlapping region; and
adding the overlapping group to the grouped subsets of the PG routings for analysis.

8. (canceled)

9. A method, comprising:
grouping subsets of Power Grid (PG) routings from a plurality of PG routings in a circuit design;
inserting Metal-Insulator-Metal (MIM) capacitors into each of the grouped subsets of the PG routings based on a layout and spacing of the PG routings in corresponding grouped subsets of the PG routings; and
connecting, for each of the grouped subset of the PG routings, pins of each of the MIM capacitors inserted therein to associated PG routing pairs, wherein the subsets of PG routings are identified to include power routings and ground routings for a given voltage range to connect to VDD pins and VSS pins of the MIM capacitors; and wherein grouping the subsets of the PG routings from the plurality of PG routings in the circuit design includes:
identifying a first subset of the PG routings adjacent to a second subset of the PG routings in the circuit layout;
identifying an overlapping region of the PG routings shared by the first subset of the PG routings and the second subset of the PG routings;
generating an overlapping group based on the overlapping region; and
adding the overlapping group to the grouped subsets of the PG routings for analysis.

10. The method of claim 9, wherein the subset of PG routings include subsets of vertically aligned PG routings and subsets of horizontally aligned PG routings.

11. The method of claim 9, wherein a first MIM capacitor inserted into a given grouped subset of the PG routings is located a first distance from a second MIM capacitor inserted into the given grouped subset of the PG routings and a second distance from a third MIM capacitor inserted into the given grouped subset of the PG routings, wherein the first distance is different from the second distance, and wherein the first distance is measured in a direction opposite to the second distance.

12. The method of claim 9, wherein the PG routings in each individual grouped subset of the grouped subsets of the PG routings have equal lengths.

13. The method of claim 9, wherein inserting the MIM capacitors into each of the grouped subsets of the PG routings includes:
spacing the MIM capacitors according to a fixed distance at least as great as a minimum spacing distance along a length of the grouped subsets of the PG routings; and
spacing the MIM capacitors with variable distances between the MIM capacitors to align pins of the MIM capacitors with associated PG routing pairs.

14. The method of claim 13, wherein the subset of PG routings include subsets of vertically aligned PG routings and subsets of horizontally aligned PG routings.

15. The method of claim 13, wherein a first MIM capacitor inserted into a given grouped subset of the PG routings is located a first distance from a second MIM capacitor inserted into the given grouped subset of the PG routings and a second distance from a third MIM capacitor inserted into the given grouped subset of the PG routings, wherein the first distance is different from the second distance, and wherein the first distance is measured in a direction opposite to the second distance.

16. The method of claim 13, wherein inserting the MIM capacitors into each of the grouped subsets of the PG routings includes:
spacing the MIM capacitors according to a fixed distance at least as great as a minimum spacing distance along a length of the grouped subsets of the PG routings; and
spacing the MIM capacitors with variable distances between the MIM capacitors to align pins of the MIM capacitors with associated PG routing pairs.

17. The method of claim 13, wherein the PG routings in each individual grouped subset of the grouped subsets of the PG routings have equal lengths.

18. A method, comprising:
grouping subsets of Power Grid (PG) routings from a plurality of PG routings in a circuit design;
inserting Metal-Insulator-Metal (MIM) capacitors into each of the grouped subsets of the PG routings based on a layout and spacing of the PG routings in corresponding grouped subsets of the PG routings; and
connecting, for each of the grouped subset of the PG routings, pins of each of the MIM capacitors inserted therein to associated PG routing pairs, wherein the subsets of PG routings are identified to include power routings and ground routings for a given voltage range to connect to VDD pins and VSS pins of the MIM capacitors;
wherein grouping the subsets of the PG routings from the plurality of PG routings in the circuit design includes:
identifying a first subset of the PG routings adjacent to a second subset of the PG routings in the circuit layout;
identifying an overlapping region of the PG routings shared by the first subset of the PG routings and the second subset of the PG routings;
generating an overlapping group based on the overlapping region; and
adding the overlapping group to the grouped subsets of the PG routings for analysis; and
wherein inserting the MIM capacitors into each of the grouped subsets of the PG routings includes:
spacing the MIM capacitors according to a fixed distance at least as great as a minimum spacing distance along a length of the grouped subsets of the PG routings; and
spacing the MIM capacitors with variable distances between the MIM capacitors to align pins of the MIM capacitors with associated PG routing pairs; and
wherein a first MIM capacitor inserted into a given grouped subset of the PG routings is located a first distance from a second MIM capacitor inserted into the given grouped subset of the PG routings and a second distance from a third MIM capacitor inserted into the given grouped subset of the PG routings, wherein the first distance is different from the second distance, and wherein the first distance is measured in a direction opposite to the second distance.

19. The method of claim 17, wherein the subset of PG routings include subsets of vertically aligned PG routings and subsets of horizontally aligned PG routings;
wherein the PG routings in each individual grouped subset of the grouped subsets of the PG routings have equal lengths; and
wherein the subset of PG routings include subsets of vertically aligned PG routings and subsets of horizontally aligned PG routings; and

20. The method of claim 17, wherein a first MIM capacitor inserted into a given grouped subset of the PG routings is located a first distance from a second MIM capacitor inserted into the given grouped subset of the PG routings and a second distance from a third MIM capacitor inserted into the given grouped subset of the PG routings, wherein the first distance is different from the second distance, and wherein the first distance is measured in a direction opposite to the second distance.

21. The method of claim 17, wherein inserting the MIM capacitors into each of the grouped subsets of the PG routings includes:
spacing the MIM capacitors according to a fixed distance at least as great as a minimum spacing distance along a length of the grouped subsets of the PG routings; and
spacing the MIM capacitors with variable distances between the MIM capacitors to align pins of the MIM capacitors with associated PG routing pairs.
